(19) United States
(12) Patent Application Publication
(10) Pub. No.: US 2013/0288002 A1
(43) Pub. Date: Oct. 31, 2013

(54) POLYMERIZABLE COMPOSITION AND OPTICAL SHEET COMPRISING CURED RESIN LAYER FORMED THEREFROM

(71) Applicants: Hong Gu Hwang, Incheon (KR); Kyung Jong Kim, Yongin-si (KR); Chang Won Park, Yongin-si (KR); Eui Young Shin, Seongnam-si (KR); Chang Pyo Hong, Yongin-si (KR)

(72) Inventors: Hong Gu Hwang, Incheon (KR); Kyung Jong Kim, Yongin-si (KR); Chang Won Park, Yongin-si (KR); Eui Young Shin, Seongnam-si (KR); Chang Pyo Hong, Yongin-si (KR)

(73) Assignee: KOLON INDUSTRIES, INC., Gwacheon-si, Gyeonggi-do (KR)

(21) Appl. No.: 13/880,672

(22) PCT Filed: Oct. 20, 2011
(86) PCT No.: PCT/KR2011/007833

§ 371 Date: Jun. 28, 2013

(30) Foreign Application Priority Data
Oct. 20, 2010 (KR) 10-2010-0102296

(51) Int. Cl. G02B 1/02; G02B 5/04; G02B 1/00

(52) U.S. Cl. CPC G02B 1/02; G02B 1/00; G02B 5/04
USPC 428/143; 252/182.14; 522/81; 524/413; 428/179; 428/407

(57) ABSTRACT

A photopolymerizable composition and an optical sheet comprising a cured resin layer formed therefrom. The polymerizable composition has a high refractive index and excellent light resistance and is thus useful for an optical sheet assembly for a backlight unit.

### TECHNICAL FIELD

The present invention relates, in general, to a photopolymerizable composition and an optical sheet having a cured resin layer formed therefrom, and more particularly to a photopolymerization composition, the reaction of which is initiated by light to form a cured resin layer, and to an optical sheet, such as a prism sheet, which has a cured resin layer formed therefrom.

### BACKGROUND ART

Generally, in the case of a transparent optical sheet having a prism structure, the rate of increase in luminance varies depending on the refractive index of a resin forming the prism resin. Generally, as the refractive index of the resin forming the prism structure increases, the rate of increase in luminance increases. Thus, research and development has been conducted in order to increase the refractive index of the resin.

Generally, the resin forming the prism structure is made of an organic compound, and the upper limit of the refractive index range controllable by the organic compound is known to be about 1.7, indicating that the range of the refractive index is narrower than that achievable by an inorganic compound. A high-refractive-index resin consisting of only an organic compound has problems, including increased viscosity and low UV stability, which significantly limits the use thereof. Therefore, there is an urgent need for the research and development of a prism composition exhibiting significantly increased luminance.

### DISCLOSURE OF INVENTION

### Technical Problem

Accordingly, the present invention has been made keeping in mind the above problems occurring in the prior art, and an object of the present invention is to provide a photopolymerizable composition suitable for forming a cured resin layer having a high refractive index.

Another object of the present invention is to provide an optical sheet comprising a cured resin layer having a high refractive index.

Still another object of the present invention is to provide a composite optical sheet comprising a cured resin layer having a high refractive index.

### Solution to Problem

In order to accomplish the above objects, according to a first preferred aspect of the present invention, there is provided a photopolymerizable composition comprising metal oxide particles represented by the following formula 1:

RₗZrₘOₙ [Formula 1]

wherein R comprises a metal selected from the group consisting of Y, Ca, Mg and Ce, and l, m and n are each an integer ranging from 1 to 10,000.

In the present invention, the metal oxide particles may have at least one of a cubic crystalline phase and a tetragonal crystalline phase.

In the present invention, the polymerizable composition may further comprise at least one UV-curable monomer, at least one photoinitiator, and at least one additive.

According to a second preferred embodiment of the present invention, there is provided an optical sheet comprising a cured resin layer containing metal oxide particles represented by the following formula 1:

RₗZrₘOₙ [Formula 1]

wherein R comprises a metal selected from the group consisting of Y, Ca, Mg and Ce, and l, m and n are each an integer ranging from 1 to 10,000.

In the present invention, the surface of the cured resin layer may have a structured shape in which a plurality of three-dimensional structures are linearly or non-linearly arranged.

In the present invention, the cured resin layer may be formed on one side of a substrate layer.

In the above aspect, the cured resin layer may have a light diffusion layer formed on the surface thereof.

In the above aspect, the cured resin layer may have a refractive index of 1.54 to 2.0.

According to a third preferred aspect of the present invention, there is provided a backlight unit assembly comprising at least one layer consisting of said optical sheet.

### BEST MODE FOR CARRYING OUT THE INVENTION

Hereinafter, the present invention will be described in further detail.

A photopolymerizable composition according to the present invention may comprise metal oxide particles represented by the following formula 1, at least one UV-curable monomer, at least one photoinitiator, and at least one additive.

RₗZₘOₙ [Formula 1]

wherein R comprises a metal selected from the group consisting of Y, Ca, Mg and Ce, and l, m and n are each an integer ranging from 1 to 10,000.

The metal oxide particles may have at least one of a cubic crystalline phase and a tetragonal crystalline phase.

Also, the metal oxide particles may be stabilized zirconia nanoparticles or partially stabilized zirconia (PSZ) nanoparticles which have a particle size of 1 to 300 nm, and preferably 1 to 100 nm.

Stabilized zirconia is also used as grinding media and in engineering ceramics due to its high hardness and high thermal shock resistivity. During a heating process, pure zirconia will undergo a phase transformation process together with a change in the volume thereof. The addition into the zirconia structure to a certain degree of some oxides, such as Y₂O₃, CaO, MgO, and CeO₂, results in a solid solution, which is in a cubic form and does not undergo phase transformation upon heating.

Partially stabilized zirconia is a mixture of zirconia polymorphs, because insufficient cubic phase-forming oxide (stabilized) has been added and a cubic plus metastable tetragonal ZrO₂ mixture is obtained. A smaller addition of stabilizer to the pure zirconia will bring its structure into a tetragonal phase at a temperature higher than 1,000° C., and a mixture of cubic phase and monoclinic (or tetragonal) phase at a lower temperature.

The photopolymerizable composition comprising the metal oxide particles represented by formula 1 can be cured to provide a cured resin layer having a high refractive index of 1.54 to 2.0. In addition, the composition has excellent heat resistance and abrasion resistance, and thus is suitable for forming a cured resin layer for an optical sheet.

The content of the metal oxide particles represented by formula 1 in the polymerizable composition can be suitably controlled depending on the refractive index or luminance properties required of the cured resin layer, but it is preferably 5-90 wt % based on the total solid content of the photopolymerizable polymer in terms of improving luminance.

The photopolymerizable composition according to the present invention may further comprise, in addition to these metal oxide particles, at least one UV-curable monomer which may advantageously have a refractive index of 1.44 or greater at 25° C. If the refractive index of the UV-curable monomer is excessively high, it can increase the viscosity of the composition to excessively increase the surface hardness of the cured resin layer, and if the refractive index is excessively low, the refractive index of the resulting optical sheet may be reduced, making it difficult to achieve high luminance. Specifically, the UV-curable monomer(s) may have a refractive index of 1.44 to 1.60 at 25° C.

When the composition does not contain or contains a UV-curable monomer having a viscosity of 1 to 50,000 cps at 25° C. and/or a refractive index of 1.44 or higher at 25° C., it can advantageously have a viscosity of 10 to 10,000 cps at 25° C. Also, the viscosity at 25° C. of the composition can influence not only the processability of the composition, but also the surface hardness of the resulting coated resin layer and the compressive strain of the resulting optical sheet. Thus, if the viscosity of the composition is excessively high, the cured resin layer can become brittle, and if the viscosity of the composition is excessively low, the refractive index of the cured resin layer can be reduced.

Thus, if the composition contains a UV-curable monomer(s) having 1 to 50,000 cps at 25° C., the content of the monomer is preferably controlled in view of the viscosity of the composition.

In addition, the content of the UV-curable monomer may more preferably be such that the refractive index of the composition is 1.54 or higher, in view of the resulting cured resin layer. Specifically, the content of a UV-curable monomer(s) may be such that the refractive index of the composition is 1.54 to 2.0.

A UV-curable monomer that may be used in the present invention is not specifically is not specifically limited, so long as it satisfies the above-described conditions of refractive index and viscosity. Examples thereof include tetrahydroperfurylacrylate, 2-(2-ethoxyethoxy)ethylacrylate, 1,6-hexanedioldi(meth)acrylate, benzyl(meth)acrylate, phenoxyethyl(meth)acrylate, phenoxypolyethyleneglycol(meth)acrylate, 2-hydroxy-3-phenoxypropylacrylate, neopentylglycolbenzoate acrylate, 2-hydroxy-3-phenoxypropylacrylate, phenylphenoxyethanolacrylate, caprolactone(meth)acrylate, nonylphenolpolyalkyleneglycol(meth)acrylate, butanediol(meth)acrylate, bisphenol A polyalkyleneglycol-di(meth)acrylate, polyalkyleneglycol-di(meth)acrylate, trimethylpropane tri(meth)acrylate, styrene, methylstyrene, phenylepoxy(meth)acrylate, alkyl(meth)acrylate, and bisphenol F ethyleneglycol diacrylate.

From various points of view, the composition comprising the metal oxide particles may advantageously have a refractive index of 1.54 or higher at 25° C. and a viscosity of 1 to 50,000 cps at 25° C., because it can satisfy the surface hardness of the cured resin layer, the compressive strain of the optical sheet, refractive index and the like. Specifically, the composition may have a refractive index of 1.54 to 2.0 at 25° C.

The composition for forming the cured resin layer may comprise, in addition to the metal oxide particles, a photoinitiator for initiating the photopolymerization of the UV-curable monomer(s). Examples of a photoinitiator that may be used in the present invention include phosphine oxide, propanone, ketone, formate, etc.

In addition, the composition may, if necessary, comprise additives, including but not limited to a UV absorber and a UV stabilizer. Also, the composition may further comprise an antistatic agent.

The optical sheet according to the present invention can be advantageous as an optical sheet for improving luminance, if the cured resin layer formed thereon has a refractive index of particularly 1.54 or higher. Specifically, the refractive index at 25° C. of the cured resin layer may be 1.54 to 2.0.

The optical sheet according to the present invention may have a cured resin layer obtained by curing the photopolymerizable composition. In one embodiment, the optical sheet may comprise the cured resin layer formed on a substrate layer.

The resin forming the substrate layer of the optical sheet according to the present invention is not specifically limited. In view of transparency, the substrate layer may be, but is not limited to, a film made of polyethylene terephthalate, polycarbonate, polypropylene, polyethylene, polystyrene or polyepoxy resin. Preferably, it may be a polyethylene terephthalate film or a polycarbonate film. The thickness of the substrate layer may advantageously be about 10-1,000 μm in view of mechanical strength, thermal stability, film flexibility and preventing the loss of transmitted light.

Particularly, the surface of the cured resin layer may have a structured layer in which a plurality of three-dimensional structures are linearly or non-linearly arranged.

In one embodiment of the present invention, a method for manufacturing an optical sheet, the surface of which has a structured shape in which a plurality of three-dimensional structures are linearly or non-linearly arranged, may comprise the steps of: preparing a composition comprising metal oxide particles represented by formula 1 and a photoinitiator; applying the composition to a frame having three-dimensional structures engraved thereon; bringing one side of a transparent substrate film into contact with the composition applied to the engraved frame, irradiating the contacted composition with UV light, thereby forming a cured resin layer; and separating the cured resin layer from the engraved frame.

In the step of preparing the composition, at least one UV-curable monomer having a viscosity of 1 to 50,000 cps at 25° C. may be added to control viscosity and refractive index.

In the case of preparing a composition comprising a halogen-free crosslinkable derivative and at least one UV-curable monomer having a viscosity of 1 to 50,000 cps, controlling the refractive index of the composition to 1.54 or higher and the viscosity of the composition to 10 to 10,000 cps is advantageous in terms of not only the compressive strain of the resulting optical sheet, but also the surface hardness.

Meanwhile, the structured shape of the surface of the cured resin layer can vary depending on the shape of the three-dimensional structures engraved on the frame. Specifically, the structured shape of the surface of the cured resin layer may be a polyhedral shape which is polygonal, semicircular or semielliptical in cross section; a columnar shape which is polygonal, semicircular or semielliptical in cross section; or a curved columnar shape which is polygonal, semicircular or semielliptical in cross section. Alternatively, the structured shape may also be a shape comprising one or more of the above shapes. Moreover, examples of the structured shape also include a case having at least one concentrically arranged structure when seen from the top of the cured resin layer while having a structure in which peaks and valleys are formed along the concentric circle.

In addition, an optical sheet according to another embodiment of the present invention may be an optical sheet comprising a substrate layer, a cured resin layer formed from the photopolymerizable composition on one side of the substrate layer, the surface of the cured resin layer having a structured shape, and a light diffusion layer formed on the surface of the cured resin layer. In this case, the need to combine a plurality of optical sheets with each other can be eliminated, and in addition, the luminance of the optical sheet can be improved and the white lines caused by the structured shape of the surface of the optical sheet can be controlled.

### MODE FOR THE INVENTION

Hereinafter, the present invention will be described in further detail with reference to Examples, but the scope of the present invention is not limited to these Examples.

### Comparative Example 1 and Examples 1 to 5

According to the components and contents shown in Table 1 below, photopolymerizable compositions were prepared. Each of the prepared compositions was applied, according to a conventional method, to a frame engraved with three-dimensional structures (prism layer) having a function of improving luminance. Then, one side of a transparent substrate film (PET film) was brought into contact with the composition applied to the engraved frame, and in this state, the applied composition was photocured by irradiation with UV light. Then, the transparent substrate film having the cured resin layer applied thereto was separated from the transparent substrate film, thereby manufacturing prism films comprising the cured resin layer formed on one side of the transparent substrate film.

The above UV irradiation was carried out by irradiating 900 mJ/cm² of UV light from an electrodeless UV lamp (600 W/inch; Fusion Corp., USA) equipped with a type-D bulb.

Although the compositions shown in Table below were composed of the organic metal oxides together with the UV-curable monomer and the photoinitiator, it will be obvious to a person skilled in the art that such compositions in Table 1 are only examples presented to confirm the effect of the zirconia compound, synthesized by adding an oxide of at least one of Y, Ca, Mg and Ce, with respect to the refractive index, and may comprise other components and additives.

The compositions of the Examples above were evaluated in the following manner.

(1) Refractive Index of Composition

The refractive index of the composition according to each of the Examples was measured at 25° C. using a refractometer (Model: 1T, ATAGO ABBE, Japan). A light source used for the measurement of the refractive index was a D-light sodium lamp of 589.3 nm.

(2) Refractive Index of Cured Coating Layer Formed from Composition

In order to measure the refractive index of the compositions after curing, each of the compositions was applied to a PET film, after which a smooth metal plate was placed on the surface of the applied composition and then pressed down such that the thickness of the applied composition reached a thickness of 20 μm. Subsequently, using an electrodeless UV lamp (600 W/inch; available from Fusion Corp., USA) equipped with a type-D bulb, 700 mJ/cm2 of UV light was irradiated onto the PET film, followed by removing the metal plate. The refractive index of the PET film having the cured composition formed thereon was measured at 25° C. using a refractometer (model: 1T, ATAGO ABBE, Japan). The light source used for the measurement of the refractive index was a D-light sodium lamp of 589.3 nm.

TABLE 1

| | | Comp. | | | | | |
|---|---|---|---|---|---|---|---|
| | | Ex. | Ex. 1 | Ex. 2 | Ex. 3 | Ex. 4 | Ex. 5 |
| Metal | Compound | — | R = Yl = | R = Mgl = | R = Cal = | R = Cal = | R = Cal = |
| oxide | of formula 1 | | 4m = 21n = 48 | 1m = 1n = 3 | 1m = 1n = 3 | 1m = 4n = 9 | 1m = 4n = 9 |
| particles | Content | — | 20 | 20 | 20 | 20 | 30 |
| | (wt %) | | | | | | |
| UV- | Bifunctional | R712 (bisphenol F ethyleneglycol diacrylate; Nippon Kayaku Co., Ltd) | | | | | |
| curable | acrylate | | | | | | |
| monomer | Content | 99.5 | 79.5 | 79.5 | 79.5 | 79.5 | 69.5 |
| | (wt %) | | | | | | |

| | | | | | | |
|---|---|---|---|---|---|---|
| Photoinitiator (wt %) | 0.5 | 0.5 | 0.5 | 0.5 | 0.5 | 0.5 |
| Refractive index of | 1.540 | 1.665 | 1.664 | 1.658 | 1.670 | 1.696 |
| composition (25° C.) | | | | | | |
| Refractive index of | 1.561 | 1.676 | 1.674 | 1.670 | 1.683 | 1.710 |
| cured coating layer | | | | | | |
| (25° C.) | | | | | | |

As can be seen in Table 1 above, the results of measuring the refractive indices of the composition and the cured coating layer for Examples 1 to 5 and Comparative Example 1 revealed that the photopolymerizable compositions comprising the metal oxide particles represented by formula 1 can provide prism sheets having the desired refractive index.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A photopolymerizable composition comprising metal oxide particles represented by the following formula 1:
RₗZₘOₙ Formula 1
wherein R comprises a metal selected from the group consisting of Y, Ca, Mg and Ce, and l, m and n are each an integer ranging from 1 to 10,000.

2. The photopolymerizable composition of claim 1, wherein the metal oxide particles have at least one of a cubic crystalline phase and a tetragonal crystalline phase.

3. The photopolymerizable composition of claim 1, wherein the polymerizable composition further comprises at least one UV-curable monomer, at least one photoinitiator, and at least one additive.

4. An optical sheet comprising a cured resin layer containing metal oxide particles represented by the following formula 1:
RₗZrₘOₙ Formula 1
wherein R comprises a metal selected from the group consisting of Y, Ca, Mg and Ce, and l, m and n are each an integer ranging from 1 to 10,000.

5. The optical sheet of claim 4, wherein the surface of the cured resin layer have a structured shape in which a plurality of three-dimensional structures are linearly or non-linearly arranged.

6. The optical sheet of claim 4, wherein the cured resin layer is formed on one side of a substrate layer.

7. The optical sheet of claim 4, wherein the cured resin layer comprises a light diffusion layer formed on the surface thereof.

8. The optical sheet of claim 4, wherein the cured resin layer has a refractive index of 1.54 to 2.0.

9. A backlight unit assembly comprising at least one layer consisting of the optical sheet of claim 4.

10. A backlight unit assembly comprising at least one layer consisting of the optical sheet of claim 5.

11. A backlight unit assembly comprising at least one layer consisting of the optical sheet of claim 6.

12. A backlight unit assembly comprising at least one layer consisting of the optical sheet of claim 7.
